(19) United States
(12) Patent Application Publication
(10) Pub. No.: US 2005/0004844 A1
(43) Pub. Date: Jan. 6, 2005

(54) Integrating barcode scanner enabled services in existing e-commerce applications using a floating pop-up web window

(76) Inventor: Olivier Attia, New York, NY (US)

Correspondence Address: Avi Outmezguine, Scanbuy, Inc.;Suite 302, 37 West 37th Street, New York, NY, 10018, US

(21) Appl. No.: 10/420,714

(22) Filed: Apr. 23, 2003

(51) Int. Cl. G06F 17/60

(52) U.S. Cl. 705/26

(57) ABSTRACT

The invention is disclosed and declared to upgrade any existing e-commerce web sites with a new feature to allow/enable barcode scanning services without requiring a change of the customer's online environment or a large integration process with the current e-commerce application provider. The additional barcode scanner enabled services and products, as the one referred to herein as ScanClik™, are available for the customer either on a floating pop-up web application interface (on top of the current web site) or a browser toolbar. Thanks to the invention, very easily and without undue interference with the existing e-commerce web-site, the web-site customers have the ability to upload barcode data from any barcode scanner device to an intermediary window and eventually post it to the current shopping cart of the customer, and the ability to print customized catalogs and labels (with barcodes) from any list displayed on the e-commerce application and from the shopping cart.

### FIELD OF INVENTION

This invention relates to the system, and method for easily and rapidly integrating barcode scanner enabled product and services into existing e-commerce application-provider, thus upgrading the exiting web-sites

### BACKGROUND OF INVENTION

Prior to the invention the process that an existing e-commerce web site should have undergone to interface with a handheld barcode scanner and/or scanning technology was painfully long and complex. It requires an extensive integration process, and many changes to the e-commerce application-provider.

Any client wishing to utilize a barcode scanner services and products would need to first register with the providing company and obtain the required software. Once they have the software, the user must go through an extensive and sometimes very complicated setup process. Many changes are necessary in tight network configurations in order to allow users to install software on their machines. Also, the software consumes system resources and require a constant internet connection. These are all factors that contribute to degrade performance of a user's machine unnecessarily.

The existing e-commerce sites, desiring to upgrade their websites would need to undergo changes and modifications on their end to handle data being passed to them from this software. The e-commerce needs to add complex processes in order to handle and parse this data in addition to their current processes. For large e-commerce sites, this can mean causing parts (or even the whole) of their site to be rendered unoperational if not carefully planned and implemented.

The process take the users away from their primary dealer's site. Since the process would be stand-alone, there is no relation between the two distinct methods (manual entry and scanner input). It is very difficult to monitor the environment in which the user is working and entering their order. Since the user's atmosphere is different, there is no correlation in the user's mind regarding this service and the dealer's service; it appears to be two completely distinct features.

In addition any change made to the existing e-commerce platform affects the software application, thus making the software unoperational and useless. This places a very strict limitation as far as what the e-commerce platform can make available to their customers, thereby prohibiting growth.

The present invention resolves the foregoing problems, allowing a very easy, and fast integration of upgraded scanning technology services with extremely limited interference with the existing e-commerce.

### SUMMARY OF INVENTION

The invention has been conceived as a floating pop-up web application interface, which gets loaded in the client's browser upon a click by the user, which is served from the central web server. The theory behind this model is to provide the easiest integration process with existing e-commerce platforms.

Links to the application are provided on the existing dealer sites to open the pop-up application interface on top of the existing web site. This is done to provide the user with a unified feel/environment. The existing web site occupies the mainframe, which covers the entire area of the client's browser while the pop-up application window is displayed at a fraction of the size on top of this first window. The small application window serves the purpose of providing the client with the barcode scanner enabled services such as upload, clear, and print/list management functions. In simple terms, dealers will be provided with links such as: “http://www.scanclik.com/app/app_name”.

The current model allows the transfer of data and population of the client's shopping cart on the existing e-commerce system from an external interface by providing a list of SKUs (Stock Keeping Units) and other relevant information passed to the back-end of the appropriate web interface. The integration utilizes this node to be effortlessly combined with the parent system.

The pop-up window interface offers users and dealers many benefits. The user is never away from their dealer's site (they will never feel as if they have left the dealer's platform) and so they have all the options and functions offered by the dealer still available to them on their screen. For the dealer this translates into a very strong relationship with the user since the user will feel that this service is being provided specifically by the dealer and not a third-party. The colors are blended with the site's colors in order to provide a uniform look and feel.

The barcode scanner enabled services site will be boosted further by the following features once integrated with the process mentioned above. It will enable the customers to scan item barcodes and upload/transfer this information to the e-commerce website, to clear the scanner whenever needed, and to print customized barcoded catalogs on-the-fly.

### BRIEF DESCRIPTION OF DRAWINGS

FIG. 1: System Architecture of the System

Diagram 1 illustrates the system architecture of the ScanClik solution (from a physical view). The system architecture as presented here is very standardized and based on Microsoft's Distributed interNet Architecture (DNA).

FIG. 2: Process Flow of the System

Illustrates the implementation level architecture providing a complete overview of how the system processes.

FIG. 3: Screenshots of the Application

Screenshots of the application accessed through an existing e-commerce platform.

FIG. 4: The Temporary Shopping Cart

A screenshot of the temporary shopping cart is displayed to the user after he/she has initiated an upload. This temporary shopping card provides the user with an opportunity to review their order before they proceed to execute anything.

FIG. 5: Items After They have been Sent to the Shopping Cart on the Dealer Site.

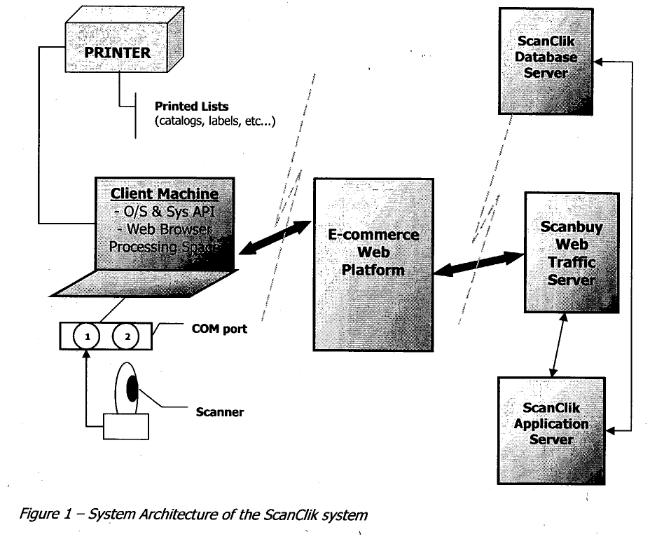

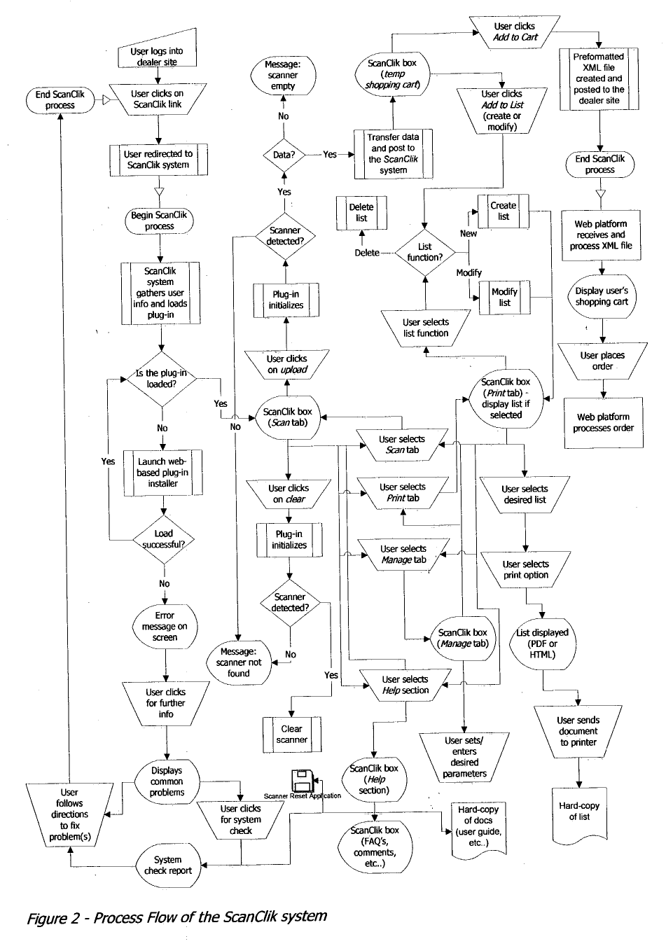

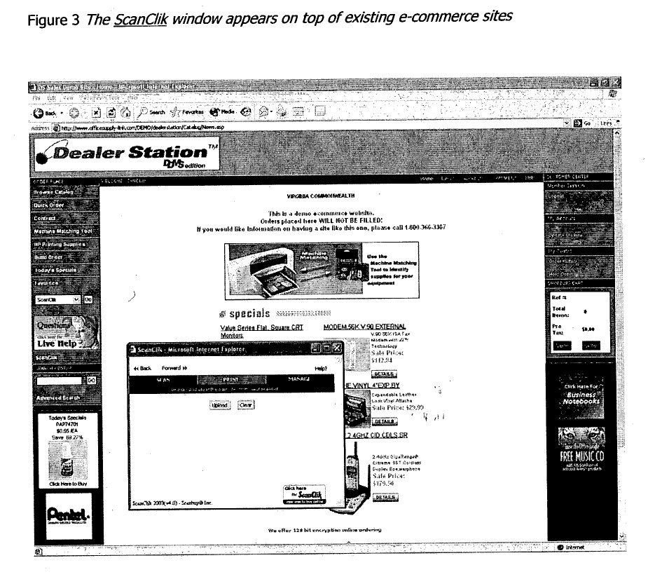

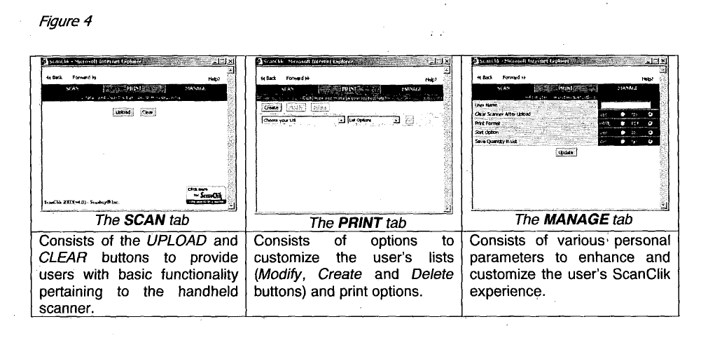

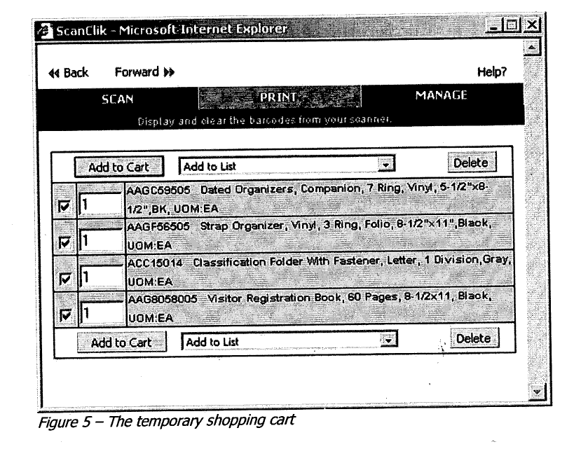

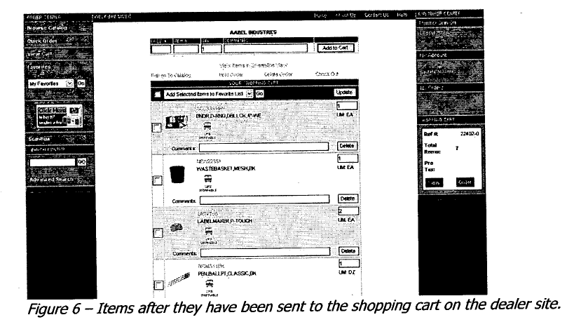

A screenshot of the following operation: Once Add to Cart has been clicked from the temporary shopping cart, the application window will be closed and the shopping cart will be displayed on the dealer site (in the browser window the user had previously opened to log-in).

### DETAILED DESCRIPTION OF THE INVENTION

The premise of the invention is to provide the easiest and swift integration process of barcode scanning technology with existing e-commerce platforms. Links to the application are provided on the existing dealer sites to open the pop-up application interface on top of the existing web site. This is done to provide the user with a unified feel/environment. The small application window serves the purpose of providing the client with the barcode scanner enabled services such as upload, clear, and print/list management functions. In simple terms, dealers will be provided with links such as: “http://www.scanclik.com/app/app_name”.

The invention permits the transfer of data and population of the client's shopping cart on the existing e-commerce system from an external interface by providing a list of SKUs (Stock Keeping Units) and other relevant information passed to the back-end of the appropriate web interface. The integration utilizes this node to be effortlessly combined with the parent system. It's imperative that the browser not allow client-side script to access elements (information) of the main window. This is crucial to ensure security. The functionality (barcode scanner enabled services) provided by the application should only be available to users who are logged in to the e-commerce platform. This is to provide a means to identify the information retrieved from the scanning device to a particular user and therefore requires a way to identify the user when uploading items to their shopping cart. This identification must be provided by the e-commerce platform, and would be included in the link to the application.

The system does not change the existing e-commerce web application in any way and leaves the existing functionality alone. The web site's contents or logic may change in the future, but this will not drastically affect the functionality provided by the pop-up application as long as the following data is available (negotiated and explained during the short integration process): (a) user information for identification, (b) a way to access the shopping cart by making an HTTP POST to transfer data to the e-commerce platform.

The invented application used the pop-up window, initiated with a simple click on a hyperlink (button or text) provided on the e-commerce site to the user. The integration process just involves setting up this one hyperlink from the perspective of the platform. In this hyperlink, the platform will pass information such as the user ID, current session ID, and color variables (in order to blend in with the site), as well as two URL's (one to transfer the information to, and the other to view the shopping cart)

The temporary shopping cart is displayed to the user after he/she has initiated an upload. This temporary shopping card provides the user with an opportunity to review their order before they proceed to execute anything. From this screen, the user is able to edit the quantities associated with items, uncheck items they may no longer want included, delete items, add the items to their shopping cart on the dealer site, or add items to an existing or new list.

Once the pop-up window is opened, the user has features not available to him/her prior to the set-up of the pop-up windows, on the e-commerce application. He/She can “upload” data from the scanner to the scanning application. From here, the user can modify any pertinent information regarding their order. When ready the user needs to click on “Add to Cart” in order to send this data to the dealer site (or as far as the user is concerned, he is simply adding this information to his dealer's shopping cart). The application takes the data and formulates an XML file containing all the necessary information. This includes the user ID, session ID, and the data scanned. This XML file is automatically sent to the e-commerce site (to the first URL provided in the abovementioned hyperlink). The application closes and the user is redirected to their shopping cart on the dealer site where his items are displayed.

Thus the scanning technology is easily integrated due to its subtle and unobtrusive design. It does not require anything on the existing e-commerce end other than to provide a hyperlink. It is able to adapt itself to the current process of the dealer web site. The XML file being submitted conforms to the existing processes of the dealer site, and requires no change on that end. Moreover, if a dealer does not wish to receive an XML file, this data can be passed back in any format requested (including a QueryString for the most simplistic methods). Also in the case of a change on the e-commerce platform in the future, the invented application would continue to function without difficulty since the information needed is contained entirely in one line of code (the hyperlink). This provides high flexibility to the existing solution providers in terms of growth for the future.

The invention will enables the customers to scan item barcodes and upload/transfer this information to the e-commerce website, to clear the scanner whenever needed, and to print customized barcoded catalogs on-the-fly.

The system architecture of the intervention, as illustrated in Drawing 1, is based on Microsoft's Distributed interNet Architecture (DNA). Drawing 1 depicts three separate components functioning jointly.

The client-end comprises three elements: The scanning device, a handheld wireless device with which users are able to scan item barcodes. The scanner communicates with the client machine through a COM/Serial port (communication can also be achieved through a USB port, but for the purpose of simplicity, this document will continue to refer to the serial port). The application transfer data from the scanner by means of an embedded scanner plug-in. The scanner plug-in is transparent to the user and there is no configuration necessary on the client-end. The plug-in is loaded upon a user's first access of the application. The client's machine (computer) represents the user's gateway to the internet (through a web browser (Internet Explorer)). Also the machine contains the system API (Operating System), which is mentioned here because it is necessary for communication with the scanning device. In addition, the machine provides communication with the scanning device through its COM port(s) (as explained above). The client is able to access their respective dealer's website (which is portrayed here simply as the existing e-commerce web platform for simplicity) through their web browser. Communication with the platform is transparent for the user. As stated earlier, this is because the goal of the invention is to extend the capabilities of existing e-commerce platforms, while making the process invisible to the end-user. The user should never feel that they have left their dealer's website, thus making the process a comfortable one and a more widely accepted one. The printer will allow the end-user to print their customized catalogs and labels.

The existing e-commerce platform, as illustrated in Drawing 1, can be separated to distinguish between individual dealer sites (direct customers who have a storefront with the abovementioned platform), and the platform provider themselves. The platform, as defined here, is responsible for handling customer orders, and providing a means to purchase online. The platform will also be thought of as the provider of the invention, since the transfer of service being offered is invisible to the end-user.

The application integrated is the means of translating the data uploaded by the user into a meaningful format and sending the order to be processed by the user's dealer (or platform provider). Web servers intercept traffic and route it to the appropriate destination. Moreover, the application provides an intelligent and meaningful to handle user created lists, and customizations. Detailed features have been defined in the previous sections of this document.

This is how the invention and the scanning technology process flow as depicted in Diagram 2 functions. The user navigates to his/her e-commerce web site (existing process). The user then clicks the dedicated link provided on the site. The small invented application window will open on top of the existing dealer window at this point. The system checks to see if this is a new user, and gathers data accordingly to provide the user with the best experience possible. The system will check to see if the plug-in is loaded, if it is not, it will prompt the user to accept it and the user will be shown the Scan tab.

The user clicks on Upload and the system starts transferring data from the scanner to the application. The user is then shown the temporary shopping cart with the items that were uploaded from the scanner where the user may review the items for deletion, or modification (of quantities). Finally, the user may add these items to a list (an existing or a new one), or add the items to their dealer's cart (the Pop-Up window will be closed, an XML file with a preformatted schema will be generated and sent to the dealer website platform and the user will be taken to the dealer shopping cart). The user clicks on Clear and the system initiates the clearing of the scanner. The user clicks the link on the bottom of the page to see a demo of the application. A small flash presentation displays in a new window.

The user selects his/her desired list from the dropdown, then selects the type of list they want (catalog, labels, etc. . . . ) and clicks on the button labeled Go. The list is generated in the appropriate format (PDF or HTML—see Manage tab), and presented on-screen to the user. The user can print a hard-copy of this list by sending it to the printer. The user can create, modify, or delete lists. In order to create a list, the user must click on the Create button—then enter Skus and click on Update. In order to delete or modify a list, the user must select a list from the drop-down menu and then click on the appropriate button (Modify or Delete). Clicking on the Delete button will delete the list, and clicking on the Modify button will display the list for modification to the user. From here they may select sku's to delete, add skus, or edit quantities (see Manage tab). The system will provide a confirmation message in all these cases in the upper-left corner of the box.

The user is able to customize his/her application experience by setting preferences on the preference tab. Following is a brief list, and explanation of the customizable options. Username: The logon id used on the e-commerce site. This is used to provide a unique set of lists provided by the dealer to a group of users. Clear Scanner after Upload: Yes or No. This option determines if the scanner should be cleared after an upload. Alternatively, the user may elect to clear the scanner manually (using the “Clear” button on the Scan tab). Print Format: PDF or HTML. Determines which format the user prefers lists to be printed in. Sort Option: Yes or No. Determines if the list should be sorted (by Category). Save Quantities in List: Yes or No. Determines if the user wants to save quantity information with a list. This can be edited from the list view (when this option is turned on), and quantities would be sent to the shopping cart also when selected. Print Combined Barcodes: Yes or No. Determines if combined barcodes should be printed (product reference and quantity), so that scanning separate quantity barcodes can be eliminate.

The user has many documents and functions available to him/her. Following is a brief description of each (Note—All documents are provided in PDF format unless otherwise specified): FAQ's: This section provides many common questions and answers about the application. This should be the first place users turn to for answers to their questions or even for general information. Your Comments: This section provides users with a way to communicate their comments and suggestions about the ScanClik application to the team. User Guide: This manual explains all features of the application. Client Setup Directions: This guide presents basic setup instructions targeted towards network administrators. This document will only be necessary for those clients who are behind a strict network setup. CS1504 Guide: This manual outlines the functionality of the CS1504 (keyfob) handheld cordless scanning device. CS2000 Guide: This manual outlines the functionality of the CS2000 handheld cordless scanning device.

The user has a few scanner utilities available to him/her. Following is a brief description of them: Scanner Use Summary: Provides an on-screen summary of the current session's scanner activity including any system messages. Scanner Reset: Provides the user with a downloadable application that can be used to perform a factory reset of the scanner in case it stops working. ystem Compatibility Check: Provides the user with a means to check his system for the application compatibility. Upon click, a new window will appear that will automatically check the user's system setup to determine if there is anything that might cause the application not to function properly. It also provides a means to submit this information directly to the ScanClik team.

1. A computer-based system to upgrade existing websites of e-commerce service providers in offering additional services with very limited or no integration, and without interfering with the existing site through floating pop-up web application interface on top of the current web site or a browser toolbar, whereby the pop-up web application includes the additional services, such as services related to the scanning technology, and therefore upgrading the existing site.

2. A computer-based system to upgrade existing websites of e-commerce service providers in offering additional services with very limited or no integration, and without interfering with the existing site through floating pop-up web application interface on top of the current web site or a browser toolbar as in claim 1 that processed the data uploaded and transferred the data to the current website for the purpose of being processed.

3. A computer-based system and method for existing websites of e-commerce service providers in offering additional services with very limited or no integration, and without interfering with the existing site through floating pop-up web application interface on top of the current web site or a browser toolbar to upgrades as in claim2 1 and 2 comprising:
(a) A pop-up window which include the new services that upgrades the site, which comprises the features of the new services;
(b) The transfer of the data processed on the floating pop-up web-application, from the same into the site of the e-commerce service provider; and
(c) The transfer of the data to the shopping cart of the website e-commerce ready to be purchased.
